(19) United States
(12) Patent Application Publication
(10) Pub. No.: US 2005/0065854 A1
(43) Pub. Date: Mar. 24, 2005

(54) Methods and apparatuses for informing, surveying and marketing to potential customers

(75) Inventor: Lina Strand Backman, Gothenburg (SE)

Correspondence Address: BURNS DOANE SWECKER & MATHIS L L P, POST OFFICE BOX 1404, ALEXANDRIA, VA, 22313-1404, US

(73) Assignee: SCA Hygiene Products AB, Goteborg (SE)

(21) Appl. No.: 10/667,449

(22) Filed: Sep. 23, 2003

(51) Int. Cl. G06F 17/60

(52) U.S. Cl. 705/26

(57) ABSTRACT

The disclosed methods include processes for educating or informing, surveying of and marketing to people about a new product by morphing characteristics of a known product to more closely resemble another known product in order to visualize features, characteristics, functions and advantages of a new product represented in an intermediate visual depiction created as a result of the morphing.

### BACKGROUND OF THE INVENTION

1) Field of the Invention

The present invention relates to apparatuses and processes for providing instruction about a subject or means; for testing or grading a person's knowledge or understanding; for displaying for purpose of comparison contrast, or demonstration; demonstrating characteristics and advantages of apparatus, objects, or processes, and in particular for demonstrating apparatus, product, and/or surface configuration, and for showing the working of, or exhibiting: any manufactured apparatus, product or device, the shape of a surface, and/or instructional subject matter and/or routines, and more particularly for comparing characteristics of plural articles or materials wherein two or more similar articles, processes, routines, surfaces and/or products are displayed so that differences in quality or characteristics can be recognized and appreciated.

2) Brief Description of Related Art

Providing information to people is an essential component to society. Advertising by definition is the conveyance of information regarding products, services or ideas in a format to educate, inform and persuade a perspective consumer about them. Surveys provide those conveying information about products, services or ideas with the sense of how well they are doing in conveying the information and an understanding of what information the survey subjects of the panel of subjects is willing to accept and/or adopt. Education of or informing people is a component to both these endeavors as well as others.

While advertising may be generally viewed as an inconvenience by some prospective consumers, the fact remains advertising educates the consuming public as to the availability of products, services or ideas in an informative and often visual manner. Of course, the purpose of an advertisement is to make people want to buy the product or service or accept the idea and the present invention is not limited to advertising alone.

An inherent problem with advertising is that the target audience often has preconceived notions about various characteristics of a product, service, process or idea, and changing these notions can be difficult. Further, language barriers can create additional difficulties in persuading individuals as to the merits of a new product, service or process.

These problems exist in the area of feminine hygiene products, for example. Generally, asking consumers about their opinions is very important to product development work. If a product involves very imaginative, visionary products such as intralabial sanitary towels or napkins, it might be difficult to convince a prospective customer that she should like the product. The reason is that some customers are anchored in preconceptions based on products currently on the market with which they are familiar. Consumers sometimes have difficulty envisioning new and creative ways to solve the same general problem.

One example is if a prospective consumer is shown a very small sanitary towel or napkin, the effect can be that she cannot focus on the benefits of the product, such as convenience, discretion and comfort. Instead, some prospective consumers tend to believe that it is not possible to develop such a small product with enough capacity, despite assurances to the contrary.

### SUMMARY OF THE INVENTION

One way to convince a potential consumer of the merits of a new product, be it a new physical product, process, routine or material, is to visually show how the product emerges out concepts and designs, aspects, or approaches of known products on the market. The know products can be “morphed” by a series or continuum of visual presentations, whether still images, moving images, prototypes or models, that show the transformation of a known product into the new product that highlights how the desirable characteristics, functions, etc. are found in the new product, even though it might look much different. In this instance, morphing can be defined as the visual transformation of one image into another by gradually distorting the first image so as to move certain chosen points to the position of corresponding points in the second image, or simply a series of images that in combination shows the transformation of the appearance of a first object to look more like another object. The visual transformation can be through animation or other moving type images, but more broadly can include a relatively small number of still images that show stages of transformation between known product(s) and the new product.

In this way, a consumer can visually understand the attributes of the new product as well as the advantages gained, thus potentially gaining acceptance and approval of the new product.

The present invention involves a process of informing potential consumers of a new product, including in no particular order:
presenting to a potential consumer a visual presentation of a first, known product having at least one function and at least one characteristic capable of visualization;
presenting to said potential consumer visual presentation of a second, known product having at least one known function substantially similar to said at least one function of the first known product and at least one characteristic capable of visualization; and
presenting to the potential consumer one or more intermediate visual presentations of at least one of the first and second products by changing the appearance of the one characteristic one product to more closely resemble the one characteristic of the other product, one of the intermediate visual presentations being an visual presentation of the new product.

The present invention also includes a survey process, including identifying a panel of people; informing panelist in the panel of a new product mostly as described above; and questioning the panelist about the impressions the panelist has of the product.

The present invention further includes a process of marketing and advertisement for a new product to potential customers, including obtaining attention of a potential customer; informing the potential customer of a new product as described above; and informing the potential customer of a source of the new product.

The processes of the present invention can be carried out in person using prototypes or models or through images presented on a computer, perhaps over a network such as the Internet, or over a broadcast system such as broadcast or cable television.

### BRIEF DESCRIPTION OF THE DRAWINGS

The present invention will be described by way of exemplary embodiments shown in the accompanying drawing figures.

FIG. 1 is a flow chart of a process for informing potential consumers of a new product, in accordance with the present invention.

FIG. 2 is a flow chart of a survey process in accordance with the present invention.

FIG. 3 is a flow chart of a process of marketing a new product to potential consumers in accordance with the present invention.

FIG. 4 is a computer network for carrying out a process in accordance with the present invention.

FIG. 5 is a broadcast system for broadcasting information in accordance with the process of the present invention.

FIGS. 6a-6g are illustrative examples of two known end-point products and a series of intermediate products.

### DETAILED DESCRIPTION OF PREFERRED EMBODIMENTS

As used herein, “products” includes physical products, articles, apparatuses, devices, materials, compositions and micro and macro structures, processes and routines, etc. In an exemplary example, feminine hygiene products are identified, but of course much broader applications of the disclosed processes are envisioned. Also, the term “consumer” is used in a broad sense to include any person regardless of how likely or unlikely it may be that that person consume a product, e.g., a man can be considered a potential consumer of a feminine hygiene product because for instance he may refer a woman to the product. Further, “visual presentation” should be given a broad definition to include still images, moving images and animations, models or prototypes or any other means to visually present characteristics or functions of a product.

Information Dissemination and Education Process

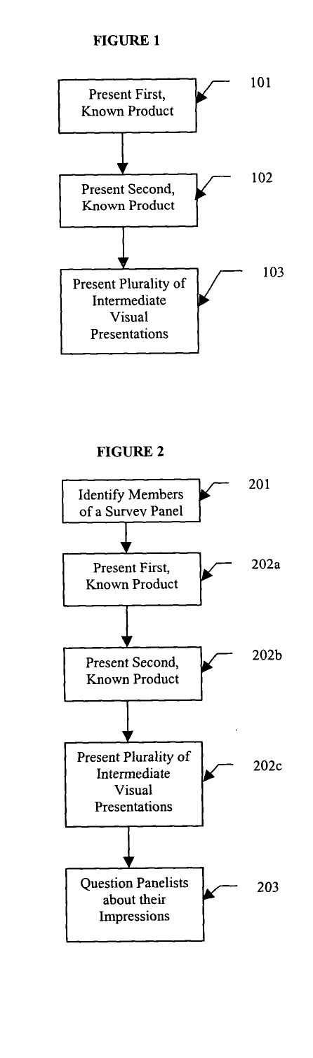

The present invention involves a process of informing potential consumers of a new product. FIG. 1 illustrates an exemplary flow of the process. In the first step 101, the process presents to a potential consumer an visual presentation of a first, known product having at least one function, such as absorbing biological fluids of women (menstrual flow and/or urine) and at least one characteristic capable of visualization or illustration, such as the shape, thickness, width and/or length of a sanitary towel or tampon. As explained elsewhere herein, the mechanism for presentation can be using images or prototypes or models, in person or remotely over a network or broadcast system. In one example, the first, known product may be a generic sanitary towel, which is designed to absorb or catch bodily fluids outside a women's body.

In a second step 102, the process presents the potential consumer an image of a second, known product having at least one known function substantially similar to the function of the first known product and at least one characteristic capable of visualization. For instance, the second known product might be a common tampon, which absorbs menstrual flow inside a women's body. There, of course, is no particular reason a tampon could not be shown to the prospective consumer before a towel, and the order can be reversed.

In a third step 103, the process presents to the potential consumer a plurality of intermediate visual presentations of products changing the visual appearance of at least one characteristic of the first product to more closely resemble at least one characteristic of the second product, one of the intermediate visual presentations being an a visual presentation of the new product. For instance, the intermediate visual presentations can be of the common sanitary towel progressively becoming smaller and profiled, e.g., the length of the towel progressively becomes shorter while the uniform thickness of the towel progressively swells at a central area into a projection resembling to some degree a tampon. Hence, the third step would introduce a new product, such as the intralabial towel. Intralabial towels are disclosed for instance in U.S. Pat. Nos. 6,579,272; 6,554,813; 6,524,291; 6,425,890; 6,350,257; 6,325,786 and U.S. patent application Ser. No. 2002 0193758 A1, all herein incorporated by reference. The third step can occur between the first and second step. In this order, the potential customer is provided with an initial pleasing familiarity with the first known product, an informative experience in viewing the intermediate visual presentations, and finally reassured with the presentation of another known product.

Additionally the process can further include presenting to the potential consumer a plurality of intermediate visual presentations of products changing the appearance of at least one characteristic of the second product to more closely resemble at least one characteristic of the first product, wherein one of the intermediate visual presentations being a visual presentation of the new product. For instance, a tampon can appear to “melt” by sequential presentation of intermediate images such that its elongated, vertical shape appears to widen at a lower end to form the shape of a towel, perhaps reflecting the contours of the female form but with a projection formed by the residual top of the tampon. For instance, the tampon could be depicted as a normal tampon that softens and flows out of a visual depiction of internal female anatomy to adopt the general form of the space between labia, and perhaps further to form a pad with an edge contour reflecting the position of legs at the crotch to show the mechanism for keeping the product in the place that the fluid leaves the female body. At some point in the progression, an intralabial or small contoured towel would be visually depicted, for example.

It should further be understood that the progression of visual presentations can be reversed. For instance, an intralabial towel can be visually presented but its function not identified to create a sense of curiosity. Its visual presentation would then be transformed into a commonly recognized product such as a tampon or towel.

As explained above, the plurality of intermediate visual presentations can be still images, moving images or animations, models or prototypes.

A Survey Process

A survey process is often of great importance. For instance, a survey can be used to determine just how much variation from known products a potential consumer might be willing to accept. A survey process as illustrated in FIG. 2 includes a first step 201 of identifying a panel of people, i.e., one or more people who will be asked about their impressions regarding a product for instance. A second step 202 includes informing panelist of a new product.

This step 202 of informing the panelist includes the steps of presenting to a panelist a visual presentation of a first, known product having at least one function and at least one characteristic capable of visualization (step 202a). For instance, a generic feminine hygiene product such as a towel could be used, as in the example above. The informing step would then include presenting to the panelist a visual presentation of a second, known product having at least one known function substantially similar to the function of the first known product and at least one characteristic capable of visualization (step 202b). Again, as with the example above, this could be a tampon. Thereafter, the informing step would include presenting to the panelist a plurality of intermediate images of products changing the appearance of the characteristic of the first product to more closely resemble the characteristic of the second product (step 202c). The intermediate images or other visual presentations would “morph” one of the known products into the new product through a series of intermediate images.

Of course, the survey process includes questioning the panelist about or otherwise gathering the impressions the panelist has of intermediate and known products (step 203).

It should be noted that the selection of the panelists can be done either before or after the known and/or intermediate products as presented. For instance, a panel can be selected and only the panel exposed to the presentations. Alternatively or additionally, panelists can be selected from a population of people who saw the presentations, as might be done in telephone surveys during a television ad campaign.

A survey process can include comprising questioning a panelist specifically about impressions the panelist has of the product, wherein the panelist had not been previously informed of the product. More specifically, the survey process can further include presenting to a selected panelist a plurality of intermediate images of products changing the visual appearance of at least one characteristic of the second product (e.g., a projection for insertion into a vagina of a tampon) to more closely resemble at least one characteristic of the first product (e.g., an external towel of largely uniform thickness), such that one of the intermediate images, prototypes or models being that of the new product (e.g., an intralabial towel that partially inserts or registers with the female anatomy but remains largely outside her body to catch the fluid where it leaves the body, while being discreet or nearly invisible under clothing).

The survey process can use a plurality of intermediate visual presentations that are still images or moving images or animations of the products, or prototypes or models, or any means to convey a visual impression of the known and intermediary products.

Results of such a survey process can vary. For instance, the usage, motivations for product selection and attitudes of the users to towels, tampons and the new product can be judged. The perception, such as the reliability of the product of towel sizes can be determined and the evaluation of prototypes recorded. Areas of perceived problems with the products and psychological barriers to such products can be uncovered. All these factors and more can then be used to evaluate the concepts that have been developed or should be developed for new products. Such a survey can indicate a need for an alternate approach to both the towel and tampon methods that provides more discretion, less visibility while providing the comfort of tampons combined with the non-intrusive character of towels.

It should be noted that the survey can be used less as an educational tool, but as a way to gage how much innovation or change a consumer group is willing to accept, including specific impressions regarding specific characteristics of a new, proposed product. In this way, a manufacture can manufacture the product corresponding to the visual presentation found most acceptable to the survey panel.

Marketing Processes

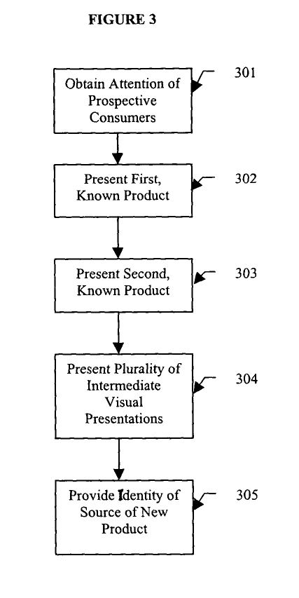

A similar process can be used to market a new product, process or idea. Such a process of marketing a new product to potential customers includes obtaining attention of a potential customer (step 301) such as shown in the flow diagram of FIG. 3. The process then includes presenting to the potential consumer an image or other visual presentation of a first, known product (e.g., a generic sanitary towel) having at least one function and at least one characteristic capable of visualization (step 302). The process would also include presenting to the potential consumer an image or other visual presentation of a second, known product (e.g., a tampon) having at least one known function substantially similar to function of the first known product and at least one characteristic capable of visualization (step 303).

The marketing process would also include presenting to the potential consumer a plurality of intermediate visual presentations of products changing the visual appearance of the one characteristic of the first product to more closely resemble the one characteristic of the second product (e.g., either the sanitary towel forming a projection, or the tampon “melting” to form a pad portion as explained in prior examples) (step 304). One of the intermediate visual presentations can be an image or prototype or model of a new product. Of course, at some point or at several points, the potential consumer would be informed of a source of the new product (step 305). This can be done by identifying the trademark or trade name of the manufacturer or marketer, or by identifying the brand name or product name, with or without reference to specific retail or wholesale locations, for example.

The marketing process can include presenting to a potential consumer a plurality of intermediate images of products changing the appearance of at least one characteristic of the second product to more closely resemble at least one characteristic of the first product, one of said intermediate images being a visual depiction of the new product. For example, the tampon can morph into a more towel-like configuration, or visa versa.

In should be further noted that the plurality of intermediate images of products can be still images, moving images or animations, prototypes or models, or any other depiction of the characteristics of a product.

Finally, it should be noted that the process can be an advertisement that is distributed and displayed to prospective consumers.

Display Mechanisms

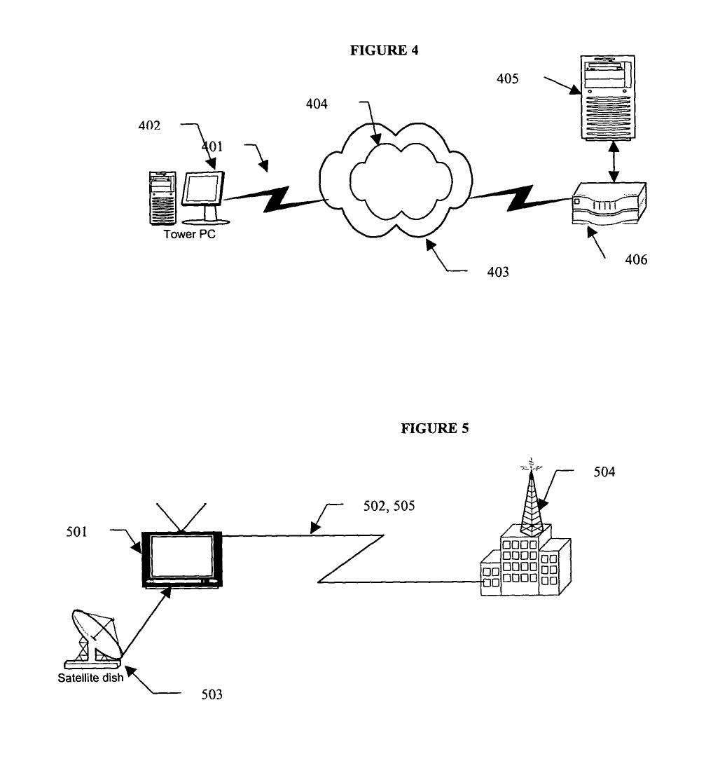

Rather than a personal interview format, the methods disclosed herein can use a display device, such as a computer screen, dynamic or still image billboard, television or movie screen. As depicted in FIG. 4, the visual presentations can be images on a computer screen 401 of a computer 402. These images can be stored in memory media in the computer 402 or transmitted over a private or public network 403, such as the Internet 404, from servers 405 and routers 406, for instance.

Alternatively or additionally, the methods disclosed herein can be carried out on TV screen 501 with images transmitted over broadcast systems such as cable TV 502, satellite TV 503, broadcast TV 504 or closed circuit TV 505, as shown in FIG. 5. Of course, more than one TV screen 501 would likely be used in a practical system. Survey steps can be conducted over the telephone, for instance.

Exemplary Visual Presentations

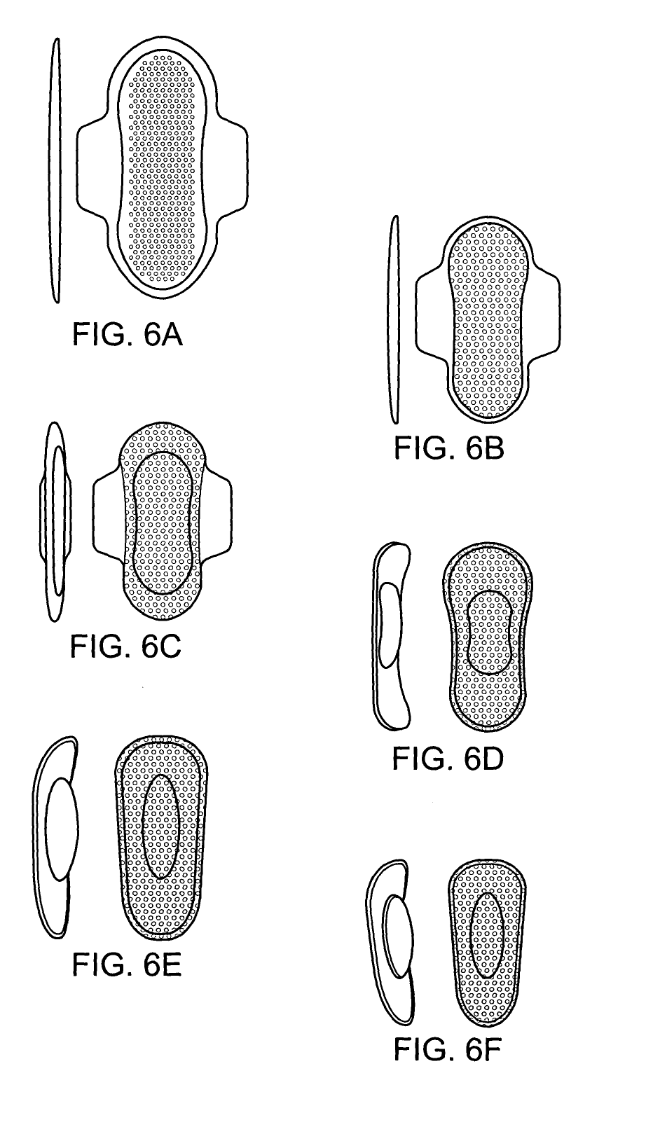

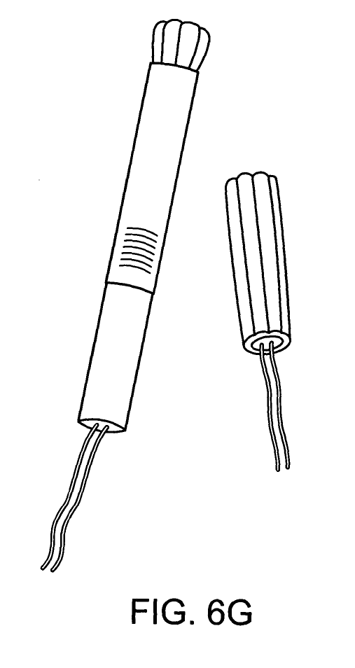

FIGS. 6a-6g show a series of images ranging from a generic sanitary towel (FIG. 6a) to a generic tampon (FIG. 6g). The intermediate images (FIGS. 6b-6f) show a progression of characteristics of the sanitary towel of FIG. 6a to be more like the tampon of FIG. 6g. For instance, FIG. 6b shows a towel with a shorter length compare to the generic towel of FIG. 6a, and the towel of FIG. 6c is shorter still. The towel of FIG. 6c is even shorter and has a more pronounced edge contour to match the position of a woman's legs near her crotch. FIG. 6d includes a pronounced projection in a central portion toward the wearer's body, and a curved surface on the pad to follow the curve of a woman's crotch. In FIG. 6e, the projection is more pronounced so as to have discernable walls on the projection extending perpendicularly from the pad portion of the towel and an even more pronounced curved pad portion. Finally, FIG. 6f shows an intralabial towel that has a very pronounced projection in a central part suggestive of the advantages of an insertion of a tampon such as shown in FIG. 6g and a strong curve following the curve of a woman's crotch to visually assure that the product will stay in place once placed correctly.

These images can form the core of an advertisement (either as a single unit or a series or units), for example, and may be supplemented by identification of a source of the new product, pricing information, packaging, text, oral disclosures and background images by way if non-limiting examples.

The methods of the present invention may be embodied in a code, which can be read by a computer, on a computer readable recording medium. The computer readable recording medium includes all kinds of recording apparatuses on which computer readable data are stored.

The present invention has been described by way of exemplary embodiment to which it is not limited. Variations and modification of the invention will occur to those skilled in the art without departing from the scope of the present invention as defined in the claims appended hereto.

1. A process of informing potential consumers of a new product, including in no particular order:
presenting to a potential consumer a visual presentation of a first, known product having at least one function and at least one characteristic capable of visualization;
presenting to said potential consumer visual presentation of a second, known product having at least one known function similar to said at least one function of said first known product and at least one characteristic capable of visualization; and
presenting to said potential consumer one or more intermediate visual presentations of at least one of the first and second products by changing the appearance of said at least one characteristic of said first product to more closely resemble said at least one characteristic of said second product, one of said intermediate visual presentations being an visual presentation of said new product.

2. A process in accordance with claim 1, further comprising presenting to said potential consumer a plurality of intermediate visual presentations of products changing the appearance of said at least one characteristic of said second product to more closely resemble said at least one characteristic of said first product, one of said intermediate visual presentations being visual presentation of said new product.

3. A process in accordance with claim 1, wherein said plurality of intermediate visual presentations of products are still images.

4. A process in accordance with claim 1, wherein said plurality of intermediate visual presentations of products are at least one of moving images and animations.

5. A survey process, comprising:
identifying a panel of people;
informing people of said panel of a new product, the informing step including in no particular order:
presenting to a panelist a visual presentation of a first, known product having at least one function and at least one characteristic capable of visualization;
presenting to said panelist visual presentation of a second, known product having at least one known function similar to said at least one function of said first known product and at least one characteristic capable of visualization; and
presenting to said panelist a plurality of intermediate visual presentations of products changing the appearance of said at least one characteristic of said first product to more closely resemble said at least one characteristic of said second product; and
questioning the panelist about the impressions the panelist has of the products presented in said plurality of intermediate visual presentations, wherein identifying a panel of people can be before or after informing people of said panel.

6. A survey process according to claim 5, further comprising questioning a panelist about impressions the panelist has of products, among products presented in said plurality of intermediate visual presentations, said panelist not having been previously informed of features or aspects of the products.

7. A survey process in accordance with claim 5, further comprising presenting to said panelist a plurality of intermediate visual presentations of products changing the appearance of said at least one characteristic of said second product to more closely resemble said at least one characteristic of said first product.

8. A process in accordance with claim 5, wherein said plurality of intermediate visual presentations of products are still images.

9. A process in accordance with claim 5, wherein said plurality of intermediate visual presentations of products are at least one of moving images and animations.

10. A process of marketing a new product to potential customers, comprising:
obtaining attention of a potential customer;
presenting to said potential consumer a visual presentation of a first, known product having at least one function and at least one characteristic capable of visualization;
presenting to said potential consumer an visual presentation of a second, known product having at least one known function substantially similar to said at least one function of said first known product and at least one characteristic capable of visualization;
presenting to said potential consumer a plurality of intermediate visual presentations of products changing the appearance of said at least one characteristic of said first product to more closely resemble said at least one characteristic of said second product, one of said intermediate visual presentations being an visual presentation of said new product; and
informing the potential customer of a source of said new product,
wherein the presenting and informing steps can be in any sequence.

11. A process in accordance with claim 10, further comprising presenting to said potential consumer a plurality of intermediate visual presentations of products changing the appearance of said at least one characteristic of said second product to more closely resemble said at least one characteristic of said first product, one of said intermediate visual presentations being an visual presentation of said new product.

12. A process in accordance with claim 10, wherein said plurality of intermediate visual presentations of products are still images.

13. A process in accordance with claim 10, wherein said plurality of intermediate visual presentations of products are at least one of moving images and animations.

14. A computer readable medium having embodied thereon a computer program for carrying out the method of claim 1.

15. A computer readable medium having embodied thereon a computer program for carrying out the method of claim 5.

16. A computer readable medium having embodied thereon a computer program for carrying out the method of claim 10.

17. An advertisement for a new product, comprising:
a visual presentation of a first, known product having at least one function and at least one characteristic capable of visualization;
a visual presentation of a second, known product having at least one known function substantially similar to said at least one function of said first known product and at least one characteristic capable of visualization;
a plurality of intermediate visual presentations of products changing the appearance of said at least one characteristic of said first product to more closely resemble said at least one characteristic of said second product, one of said intermediate visual presentations being an visual presentation of said new product; and
identification of a source of said new product.

18. An advertisement in accordance with claim 17, further comprising a plurality of intermediate visual presentations of products changing the appearance of said at least one characteristic of said second product to more closely resemble said at least one characteristic of said first product, one of said intermediate visual presentations being an visual presentation of said new product.

19. An advertisement in accordance with claim 17, wherein said plurality of intermediate visual presentations of products are still images.

20. An advertisement in accordance with claim 17, wherein said plurality of intermediate visual presentations of products are at least one of moving images and animations.
